(19) United States
(12) Patent Application Publication
(10) Pub. No.: US 2024/0237859 A1
(43) Pub. Date: Jul. 18, 2024

(54) HEIGHT-ADJUSTABLE CUTTING-BOARD ASSEMBLY

(71) Applicant: STUDIO NINABER B.V., Delft (NL)

(72) Inventor: Bruno NINABER VAN EYBEN, Delft (NL)

(21) Appl. No.: 18/559,069

(22) PCT Filed: May 4, 2022
(86) PCT No.: PCT/EP2022/062051

§ 371 Date: Nov. 6, 2023

(30) Foreign Application Priority Data
May 5, 2021 (NL) 2028152

(51) Int. Cl. A47J 47/00

(52) U.S. Cl. CPC A47J 47/005

(57) ABSTRACT

A height-adjustable cutting-board assembly is provided, said height-adjustable cutting-board assembly comprising: a support base, arranged to support the height-adjustable cutting-board assembly; a cutting-board holder, arranged to receive a cutting-board; at least two struts, said at least two struts connecting the support base with the cutting-board holder; and a securing mechanism, arranged to releasably secure the struts in one or more predetermined positions, wherein said at least two struts each comprise a top end and a bottom end, said top end being pivotably connected to the cutting-board holder and the bottom end being pivotally connected to the support base, wherein said struts are positioned substantially parallel to each other to form a moveable parallelogram lift, whereby said cutting-board holder is height adjustable in relation to the support base by pivoting the struts in relation to the support base and the cutting-board holder.

### FIELD OF THE INVENTION

The invention relates generally to a height-adjustable cutting-board assembly and more particularly to a kit of parts for assembling a food preparation surface, a food preparation surface, and a method of food preparation.

### BACKGROUND OF THE INVENTION

There is a general and ongoing need to improve the ergonomics of work in a kitchen, in particular work performed on a cutting-board.

Food preparation often requires the need to cut or slice the food prior to cooking it, such as vegetables, fruits and meats, including, chicken, beef, pork, fish and all other types of meat. Other food types may not need any cooking, such as for example fruits, vegetables. However, these food types do often still require cutting or slicing prior to consumption. Cutting-boards are often used for cutting and slicing, for among other reasons, to protect the countertop from being marred, scratched or cut by the cutting utensil. Cutting-boards also help prevent contamination of surfaces such as countertops. Since cutting-boards are often provided for specific food types, such as meat, fish, or vegetables, the cutting-boards also help prevent cross-contamination between various food types.

Conventional cutting-boards are typically a planar substrate that rests on the work surface, such as a countertop. The cutting-board has a surface upon which the food items are placed and then cut using a cutting utensil, such as a knife, a cleaver or other utensil. These conventional cutting-boards provide a surface upon which to cut without damaging the table or countertop, and without contamination thereof. However, cutting-boards are lacking in one particular aspect. The cutting-board is limited to the height of the work surface, such as a counter, upon which it rests and often causes back pain to the user. In particular, the fixed height of a countertop does not address the variation in height requirements of a user. The user, such as chefs or other cooks that are preparing food for long periods of time and on a daily basis, may suffer from back pain and may have further back trauma requiring medical treatment due to leaning over countertops of a fixed height to use conventional cutting-boards. In particular professional kitchens require cooks to be on their feet for prolonged periods of time. Often cooks are subject to longer periods of standing, resulting in back pain. In particular (substantially) taller than average cooks may suffer from such problems.

Attempts to solve this problem have resulted in conventional cutting-boards with extendable legs. These legs raise the height of the cutting surface above the countertop to a height that is more ergonomically appropriate to a taller user. This may help to avoid or alleviate the back problems of the user. However, such conventional cutting-boards with legs are also problematic. Such cutting-boards may be difficult to properly sanitize as a whole unit. As these cutting-boards are used, they will inevitably come into contact with raw meats or other food types which can result in contamination. The food, such as raw meat, comes in contact not just with the cutting surface, but also the legs and other surfaces of the cutting-board. Conventional cutting-boards do not provide a way for submersing the cutting-boards into water to sanitize properly all components of the cutting-boards. Further, the legs of such cutting-boards provide only a fixed elevation, which may still provide problems for a user, or require a professional kitchen to stock a variety of such cutting-boards. In addition, the legs are cumbersome to attach and detach, dependent on the user of a cutting-board. In particular in professional kitchens, time is a crucial factor and a lengthy procedure to change the height of a cutting-board dependent on the user is disadvantageous.

Further attempts have been described in document U.S. Pat. No. 7,849,789, which discloses an adjustable portable cutting-board having a cutting surface and at least two adjustable legs. The adjustable legs are coupled to a bottom side of the cutting surface and may be adjusted in length, wherein the legs include a locking mechanism to lock the legs at a desired length. The legs are also pivotable between an opened position and a closed position, wherein the opened position allows the cutting-board legs to be placed on a work surface and elevate the cutting surface to the desired height and the closed position rotates the legs into a position substantially parallel with the cutting surface for transporting. The cutting-board also includes a handle for carrying the cutting-board.

However, these types of adjustable portable cutting-boards may still have several drawbacks. The provision of pivotable legs to raise the cutting-board lacks stability of the cutting-board. A lack of stability of the cutting-board can be dangerous to the user since cutting is usually done with sharp tools and on occasion with relatively high forces. The use of pivotable legs can cause one side of the cutting-board to collapse upon application of a sideways force. The legs can fold in due to the exerted force, causing the cutting-board to drop. This risks serious harm to the user due to a lack of stability. Furthermore, the provision of legs limits the range of elevation. Once the legs are deployed, i.e. in their open position, the cutting-board is elevated to a certain minimum height, even if the optionally telescopic legs are provided in their shortest position. As such, there is no variable elevation between the flat state and a first level of elevation.

Another proposed solution is the provision of scissor actioned legs, which can elevate the cutting-board. The elevation is provided by raising the respective sides of the legs, which have a hinged connection at a middle point of the legs. The provision of a scissor legs arrangement also provides further difficulties. The arrangement is relatively complex to fabricate requiring many moving parts, and a complex catch and guide system provided on the top and bottom parts of the assembly is needed. Since the legs have to be quite long, e.g. about the length of the cutting-board, the material must be strong to provide sufficient structural integrity, making the materials robust, heavy and expensive; alternatively the legs will be subject to torsion and mechanical fatigue. The need for large components also limits the ability of the cutting-board to lie flat on the countertop. This leads to the requirement, also suggested in U.S. Pat. No. 7,849,789, to alter the countertop so that the adjustable cutting-board is provided beneath the level of countertop, being lifted out of the countertop when needed. This in turn leads to increased cost and limits the ability to move the cutting-board to other parts of the countertop, leading to a lack of flexibility during use.

Further, a scissor legs arrangement leads to a relative movement of at least one end of both legs with respect to the countertop and the cutting-board. Such an arrangement thus requires a roller, a guide, or the like. The movement of these parts within the arrangement may risk trapping of food particles in the mechanics. The removal of food from these parts can be difficult and possibly dangerous since a user would need to pry foods out from between the scissor legs. If the cutting-board slips or drops during the removal of food, the fingers of a user could be damaged. The use of a guide or rollers may also lead to blockage or jamming of the cutting-board assembly if food gets stuck in the guides or grooves.

There is thus a need for an improved height-adjustable cutting-board assembly to address one or more of the abovementioned drawbacks.

### BRIEF SUMMARY OF THE INVENTION

In one aspect of the invention there is provided a height-adjustable cutting-board assembly comprising: a support base, arranged to support the height-adjustable cutting-board assembly; a cutting-board holder, arranged to receive a cutting-board; at least two struts, said at least two struts connecting the support base with the cutting-board holder; and a securing mechanism, arranged to releasably secure the struts in one or more predetermined positions, wherein said at least two struts each comprise a top end and a bottom end, said top end being pivotably connected to the cutting-board holder and the bottom end being pivotally connected to the support base, wherein said struts are positioned substantially parallel to each other to form a moveable parallelogram lift, whereby said cutting-board holder is height adjustable in relation to the support base by pivoting the struts in relation to the support base and the cutting-board holder. Preferably said top end is provided in a pivotably fixed relation to the cutting-board holder and the bottom end is in a pivotally fixed relation to the support base, and said struts are substantially parallel to each other throughout raising and lowering of the cutting-board holder.

A cutting-board, or chopping board, is a durable board on which material may be placed for processing, such as cutting or chopping. A kitchen cutting-board is commonly used in preparing food. Other cutting-board types exist for cutting raw materials such as leather or plastic. Kitchen cutting-boards are often made of wood or plastic and come in various widths and sizes. There are also cutting-boards made of glass, steel, or marble, which are easier to clean than wooden or plastic varieties, but may blunt knives due to their hardness. Rough cutting edges, such as serrated knives, abrade and damage a cutting surface more rapidly than do smooth cutting implements. Materials used for the fabrication of cutting-boards include, but are not limited to, plastics, such as polyethylene preferably HDPE, wood, bamboo, silicone, glass, and steel.

The material of the cutting-board may also be antibacterial, to prevent spreading and propagation of bacterial load on the material of the cutting-board. Bacteria or allergens can easily be transmitted from one part of the kitchen to another or from one food to another via knives, hands, or surfaces such as chopping boards. To reduce risks of cross-contamination between food types, separate cutting-boards may be used for different types of food such as raw meat, cooked meat, dairy and vegetables. The cutting-boards may have colours, associated with the type of food that is handled on the board. These colours may be, for example blue for raw seafood, red for raw red meat, green for vegetables and fruits, yellow for poultry, brown for cooked meat, and white for dairy and breads.

A normal kitchen work surface, such as a countertop, is generally about 95 cm above a kitchen floor. For many users, work surfaces of standard height are not optimal. For example, the heights of the users may vary considerably such that the height of a standard work surface is not optimal or even problematic to specific users. In addition, even if a user is the correct height for a standard work surface, working at a constant fixed work surface level may still lead to back problems or other skeletal or motoric issues over time. The present invention may aid in providing easy and quick adjustment of the working height of a cutting-board.

The support base of the height-adjustable cutting-board assembly may be a substantially flat plate which acts as a support for the height-adjustable cutting-board assembly. The support base is arranged to rest on a work surface, such as a countertop or a table and provide a solid base for the device. The cutting-board holder, is arranged to receive a cutting-board so that the cutting-board is supported, preferably stabilized with respect to the cutting-board holder and preferably does not slide away from the cutting-board holder upon the application of sideways force. In an embodiment, the upper holder is arranged to grip, actively or passively, the cutting-board upon placement of the cutting-board in the upper holder. In an embodiment, said cutting-board holder is positioned opposed to and above said support base. In an embodiment, said cutting-board holder comprises a substantially flat plane, preferably arranged to uniformly support a cutting-board disposed thereon.

The at least two struts provide a connection between the support base and the cutting-board holder. This connection may also be indirect, in an embodiment. In a preferred embodiment, the struts connect directly to the cutting-board holder and the support base. The connections between the struts and the support base and cutting-board holder are pivotal, preferably hinges, so the struts can rotate with respect to the support base and the cutting-board holder. In a preferred embodiment, the hinges are provided as a simple nut and bolt connection. In another embodiment, the hinge may be provided by a rivet connection. Any other type of pivotal connection mechanism may be utilised. The rotation of the struts with respect to the support base and the cutting-board holder ensures that the cutting-board holder is raised when the struts are rotated from a substantially flat position to a more vertical position, i.e. the vertical inclination of the struts is increased. The angle of inclination and strut length determine in part the elevation height of the cutting-board holder. The elevation is thus controlled by adjustment of the vertical inclination of the struts. The lengths of the struts determine the maximum elevation of the cutting-board holder, with respect to the support base, i.e. when the struts are inclined to 90°.

The provision of the at least two struts in the form of a parallelogram allows the pivot points to remain in fixed relation to the cutting-board holder and/or the support base. That is, the hinges that connect the struts to the plates are fixed, allowing for only rotation of the struts. This arrangement thus may allow for the elevation of the cutting-board holder without the need for grooves or slots for rollers, or other mechanical arrangements found in e.g. scissor extensions, allowing for rectilinear movement. As a result, the arrangement limits the chance of jamming due to foods being stuck in such grooves or slots, or trapping of contaminating foodstuffs. Also, the arrangement is simplified, possibly leading to reduced fabrication costs and a reduced requirement of strength in components to achieve the desired structural integrity. Improved sanitization may also be achieved with fewer or simpler moving parts.

Cutting-boards are commonly planar with a thickness. Cutting-boards typically comprise a square, preferably rectangular cutting surface. Other shapes may also be used such as round or oval.

In an embodiment of the invention, the cutting-board may have a thickness of between 0.5 cm and 10 cm, preferably of between 1 cm and 8 cm, more preferably between 1.5 cm and 5 cm, still more preferably of between 2 cm and 4 cm.

In an embodiment, the cutting-board may have a width of between 10 cm and 50 cm, preferably of between 15 cm and 45 cm, more preferably of between 20 cm and 40 cm, still more preferably of between 25 cm and 35 cm. In an embodiment, the cutting-board may have a length of between 25 cm and 65 cm, preferably of between 30 cm and 60 cm, more preferably of between 35 cm and 55 cm, still more preferably of between 40 cm and 50 cm.

Round or oval cutting boards may have a radius of from 5 cm to 40 cm, preferably from 7 cm to 30 cm, more preferably from 8 cm to 20 cm. Chopping-boards may have a cutting surface of from 100 cm² to 3000 cm², preferably from 300 cm² to 2500 cm², more preferably from 400 cm² to 2000 cm².

In an embodiment, the dimensions of the cutting-board holder are substantially equal to the dimensions of the cutting-board. These dimensions can be any one of length, width, depth, volume. The provision of a cutting-board holder with dimensions that are substantially equal to the dimensions of the cutting-board leads to a tighter fit of the cutting-board in the cutting-board holder. In a preferred embodiment, the cutting-board holder and the cutting-board are rectangular, and their width and length are substantially equal. In a still further preferred embodiment, the depth of the cutting-board and the cutting-board holder is also substantially equal.

In an embodiment, the cutting-board may have a weight of between about 0.1 kg and 10 kg, preferably of between about 0.2 kg and 5 kg, more preferably of between about 0.4 kg and 2 kg, still more preferably of between 0.5 kg and 1 kg.

Preferred chopping boards may be comprised of, preferably substantially comprised of, polyethylene, preferably high density polyethylene (HDPE) and/or wood.

In an embodiment, the struts have an elongated width, so that the struts preferably form a plate-shaped structure, wherein preferably a width of the struts extends over a width of the cutting-board holder for at least about 50%, preferably for at least about 70%, more preferably for at least about 80%.

The provision of an elongated width of the at least two struts in the direction of the width of the cutting-board holder can provide structural integrity to the height-adjustable cutting-board assembly. The stability may be provided by the struts spanning an increased portion of the width of the cutting-board holder. The material choice for the struts may thus be extensive because the structural integrity is increased by increasing the width of the struts, and materials may be chosen which increase speed or reduce costs in production processes. Some prior art cutting-board assemblies limit the application of elongated struts because they operate using scissor legs arrangement. Such an arrangement cannot use struts with an elongated width because the struts must pass one another and be connected with a pivot in their middle point. The provision of struts with an elongated width is thus not possible using such an arrangement. The use of a parallelogram arrangement allows the provision of elongated struts, leading to advantages of stability, structural integrity, flexibility in material choice, ease of manufacturing, and reduced production costs.

The height-adjustable cutting-board assembly of any of the preceding claims, wherein the struts have a length between the top end and the bottom end of the struts of between about 5 cm and 20 cm, preferably of between about 8 cm and 18 cm, more preferably of between about 10 cm and 15 cm, still more preferably of between about 12 cm and 14 cm.

The length of the struts is determinative of the maximum elevation to which the cutting-board holder is adjustable.

In an embodiment, the height-adjustable cutting-board assembly has a minimum height of less than about 9 cm, preferably of less than about 7 cm, more preferably of less than about 5 cm, still more preferably of less than about 3 cm, most preferably of less than about 2 cm. The minimum height is the distance of the work surface to a supporting surface of the cutting-board holder. That is, the minimum height is the minimum extra elevation of the cutting-board provided by the height-adjustable cutting-board assembly, with respect to placing the cutting-board directly on the work surface.

The height-adjustable cutting-board assembly has a low minimum height. That is, the assembly can flatten relatively easily and to a very low height. This has as a benefit that a user can leave it in place, even if the required height of the cutting-board holder is close to the height of the work surface. Users requiring a low cutting surface may thus not need to remove the height-adjustable cutting-board assembly. The height of the height-adjustable cutting-board assembly is measured from the underside of the support base, to the top side of the cutting-board holder. In embodiments, the adjustable cutting-board may be fixedly connected to a work surface.

In an embodiment, the cutting-board holder defines a substantially rectangular shape, having four peripheral edges, wherein the cutting-board holder comprises four wall elements, extending upwardly from the peripheral edges of the cutting-board holder. In a preferred embodiment, the cutting-board holder comprises a rectangular plate. In other embodiments, the cutting-board holder may have openings or be comprised of separate cutting-board support elements.

The provision of the wall elements, extending from the peripheral edges, ensure that a cutting-board may be held on the cutting-board holder. The wall elements are arranged to cup or hold a cutting-board of a given dimension, or may grasp or clamp the cutting-board to restrict sideways movement. This facilitates increased stability during cutting. To achieve this, it is preferable that the cutting-board has dimensions which coincide with the dimensions determined by the wall elements of the cutting-board holder. When these dimensions are substantially equal, the wall elements tightly fit around the sides of the cutting-board, keeping it in place during use. In embodiments, the walls may actively grip a cutting-board by e.g. actuation of the wall elements so that they clamp down on the sides of a cutting-board.

The side-wall elements are preferably provided as upright side-walls having a height of equal to or less than the thickness of a chopping-board. If the side-walls extend higher than the thickness of the chopping board, disposal of processed foods may be blocked. In addition, such an extending edge may cause damage to a cutting utensil.

In an embodiment, the cutting-board holder has a larger width than the support base, preferably the width of the cutting-board holder is more than about 2 cm larger, preferably more than about 4 cm larger, more preferably more than about 6 cm larger, still more preferably more than about 8 cm larger. That is, the cutting-board holder laterally extends over the width of the support base.

When provided with a cutting-board holder having a larger surface than the support base, the cutting-board holder will have an overhanging edge. The lateral extension of the cutting-board holder creates an overhanging edge of the cutting-board holder. This overhanging edge may be advantageous, in particular when the cutting-board holder is slightly raised with respect to the cutting-board holder. Any debris falling from the cutting plate will land on the countertop or table, on which the height-adjustable cutting-board assembly is placed. The chance of processed food bouncing underneath the height-adjustable cutting-board assembly is reduced. As such, the overhang reduces the chance of foods getting stuck in the mechanics of the height-adjustable cutting-board assembly. Further, the overhang may be used to place bowls or bins underneath the cutting-board holder. When the top placed is raised, containers may be positioned underneath the overhang to catch food or waste. For example, waste may be disposed of in a waste basket partly underneath the left side of the cutting-board holder, while the processed food product may be collected in a container partly underneath the right side of the cutting-board holder. The same principle may apply equally to the length of the cutting-board, in an orthogonal direction to the width. In such a case, a container or a plate may be placed underneath the back edge of the cutting-board holder, or underneath the front end of the cutting-board holder, close to a user.

In an embodiment, the cutting-board holder comprises at least two notches provided at substantially opposing regions of the periphery of the cutting-board holder, wherein preferably the cutting-board holder has a rectangular shape, and wherein preferably the notches are provided in two opposing corner regions of the rectangular cutting-board holder, wherein more preferably all corners comprise notches.

The provision of notches to the periphery of the cutting-board holder ensures easy access to the cutting-board for removal and placement. A notch in the periphery of the cutting-board holder limits the possibility of a user to trap fingers between the cutting-board holder and the cutting-board and eases the access to the cutting-board upon removal. In particular in an embodiment wherein the cutting-board holder comprises peripheral wall elements, removing the cutting-board from the cutting-board holder can be difficult. Notches in the periphery solve this problem by facilitating access to the cutting-board.

In an embodiment, the support base comprises a front edge, and wherein the front edge of the support base comprises a lip extending downwardly from the front edge of the support base, the lip preferably being arranged to abut a work surface edge.

The provision of a lip, extending downwardly from the frontal edge of the support base increases stability of the height-adjustable cutting-board assembly since movement away from the edge of the work surface is prevented. The lip extends downwardly form the support base and extends over the edge of the work surface, thereby forming a structural barrier to movement of the height-adjustable cutting-board assembly away from the edge of the work surface. This further limits unwanted movement of the height-adjustable cutting-board assembly during use. While the assembly is arranged to remain stable and secured, the use of a lip may further limit undesirable movement.

In an embodiment, the securing mechanism comprises a support arm, preferably extending from the cutting-board holder, and wherein the support base comprises one or more catches, arranged to receive the support arm, preferably wherein the support base comprises at least 3 catches, more preferably at least 5 catches, still more preferably 7 catches. In a preferred embodiment, the support arm extends from the cutting-board holder. In other embodiments, the support arm extends from the support base. In such an embodiment, the cutting-board holder comprises catches to receive the support arm.

The provision of a support arm provides a simple mechanism to lock the struts in a predetermined position. The user may lift the cutting-board holder and simultaneously adjust the support arm to guide it to a catch. Once the support arm is received in a catch, the user can release the cutting-board holder, which will be held in an elevated position because the support arm prevents the downward movement of the cutting-board holder. To achieve this, it is preferable that the support arm is provided at an angle to the cutting-board holder which is different to the angle that the struts make with the cutting-board holder, for example opposing to downward movement of the struts. This way, the downward movement of the struts, which will want to rotate downwardly under the application of gravity, is prevented. In a preferred embodiment, the support arm is connected on two opposing lateral edge regions of the cutting-board holder, and extends under the cutting-board holder. In this embodiment, it is preferred that the support arm comprises a single rod, having a U-shape, the top ends of which connect to the cutting-board holder, and the bottom part extending under the cutting-board holder, over its width. The bottom part of the U-shaped support arm may then slot into catches provided on the support base. The use of a U-shaped support arm ensures flexibility in the positioning of the catches on the support base. The catches may be provided in a centre region of the support base. In a preferred embodiment, the catches may be positioned on opposing lateral sides of the support base.

In an embodiment, the support arm is connected to the support base, using a pivotal connection, and the catches are provided on a lower side of the cutting-board holder. In still further embodiments, other securing mechanisms may be used, such as e.g. pin-locking mechanisms.

In an embodiment, the support arm comprises a laterally extending engagement, preferably wherein the laterally extending engagement is positioned at a maximum distance from the a lateral edge of the cutting-board holder of about 20 cm, preferably of about 15 cm, more preferably of about 10 cm, still more preferably of about 5 cm.

The use of a laterally extending engagement increases the safety of the user. If the support arm extends directly downwardly towards the catches, the user may position fingers close to the catch mechanism, arranged to receive the support arm. To prevent a user from damaging fingers when adjusting the height of the height-adjustable cutting-board assembly, it is desirable to provide the support arm and the catches at a more inward position with respect to the lateral edges of the cutting-board holder. However, if the mechanism is too far removed from the edges of the cutting-board holder, it may be difficult to adjust the height while at the same time lifting the cutting-board holder. As such, it is desirable if the support arm comprises laterally extending engagements which a user may engage to operate the support arm without having a risk to trap fingers in the support arm mechanism.

In an embodiment, the cutting-board holder, the support base, and the struts, are fabricated from sheet metal, preferably folded sheet metal. Such metal may be steel, aluminium, copper, brass, iron, or any other type of material. In other embodiments, the cutting-board holder, the support base, and the struts, are fabricated from plastics, carbon, or the like.

The provision of struts that do not interconnect, on account of their forming a parallelogram, it is possible to use a relatively simple and cheap material such as sheet metal.

In particular in an embodiment wherein the struts have an elongated width, so that the struts form a plate-shaped structure, the use of sheet metal may reduce production challenges and production costs. The use of folded sheet metal reduces the need for welded connections, which makes production simpler.

In an embodiment, the height-adjustable cutting-board assembly is able to support a weight on the cutting-board holder of at least about 20 kg, preferably of at least about 40 kg, more preferably of at least about 60 kg, still more preferably of at least about 80 kg.

The construction of a parallelogram in the height-adjustable cutting-board assembly provides a high structural integrity while minimizing material and production costs and requirements. The height-adjustable cutting-board assembly is preferably able to withstand forces that may be encountered when processing food. Heavy duty operations include, but are not limited to slicing pumpkins, handling large pieces of meat with e.g. cleavers, and folding dough.

In an aspect according to the invention, there is provided a kit of parts, for assembling a food preparation surface, comprising: a height-adjustable cutting-board assembly according to any of the embodiments described hereinbefore; and a cutting-board, preferably wherein the cutting-board has a width and a length which are substantially equal to a width and a length of the cutting-board holder of the height-adjustable cutting-board assembly.

In an aspect according to the invention, there is provided a food preparation surface comprising: a height-adjustable cutting-board assembly according to any of the embodiments described hereinbefore; and a cutting-board provided on the cutting-board holder of the height-adjustable cutting-board assembly.

In an aspect according to the invention, there is provided a method of food preparation, comprising the steps of: providing a food preparation surface as described hereinbefore, and processing food on the cutting-board.

In one aspect of the invention there is provided a height-adjustable work-surface assembly comprising: a support base, arranged to support the height-adjustable work-surface assembly; a work-surface holder, arranged to receive a work-surface; at least two struts, said at least two struts connecting the support base with the work-surface holder; and a securing mechanism, arranged to releasably secure the struts in one or more predetermined positions, wherein said at least two struts each comprise a top end and a bottom end, said top end being pivotably connected to the work-surface holder and the bottom end being pivotally connected to the support base, wherein said struts are positioned substantially parallel to each other to form a moveable parallelogram lift, whereby said work-surface holder is height adjustable in relation to the support base by pivoting the struts in relation to the support base and the work-surface holder.

The embodiments described hereinbefore may be advantageous in other technical fields as well. For example, the embodiments described herein may be used in a laboratory setting or for electronics development and soldering. To this end, it would be advantageous to provide a height-adjustable work-surface assembly. The features described in relation to the height-adjustable cutting-board assembly may be similarly applicable to the height-adjustable work-surface assembly. The height-adjustable work-surface assembly may also be advantageous for office work stations. For example, the work-surface may be used as a laptop stand to facilitate a height-adjustable laptop surface for standing desks.

In an embodiment of the height-adjustable work-surface assembly, the work-surface holder further comprises a work-surface, preferably being plate-shaped. In an embodiment, the work-surface is fixedly connected, or integrally formed with the work-surface holder.

### BRIEF DESCRIPTION OF THE DRAWINGS

The features and advantages of the invention will be appreciated upon reference to the following drawings, in which:

FIG. 1 is a perspective view of the height-adjustable cutting-board assembly in accordance with an embodiment of the invention;

FIG. 2 is a perspective view of the height-adjustable cutting-board assembly in accordance with an embodiment of the invention, with a cutting-board disposed thereon;

FIG. 3 is a side view of the height-adjustable cutting-board assembly in accordance with an embodiment of the invention in a partially raised state;

FIG. 4 is a side view of the height-adjustable cutting-board assembly in accordance with an embodiment of the invention in a completely collapsed state; and

FIG. 5 is a perspective close-up view of the height-adjustable cutting-board assembly in accordance with an embodiment of the invention showing the securing mechanism.

### DESCRIPTION OF ILLUSTRATIVE EMBODIMENTS

The following is a description of certain embodiments of the invention, given by way of example only and with reference to the drawings.

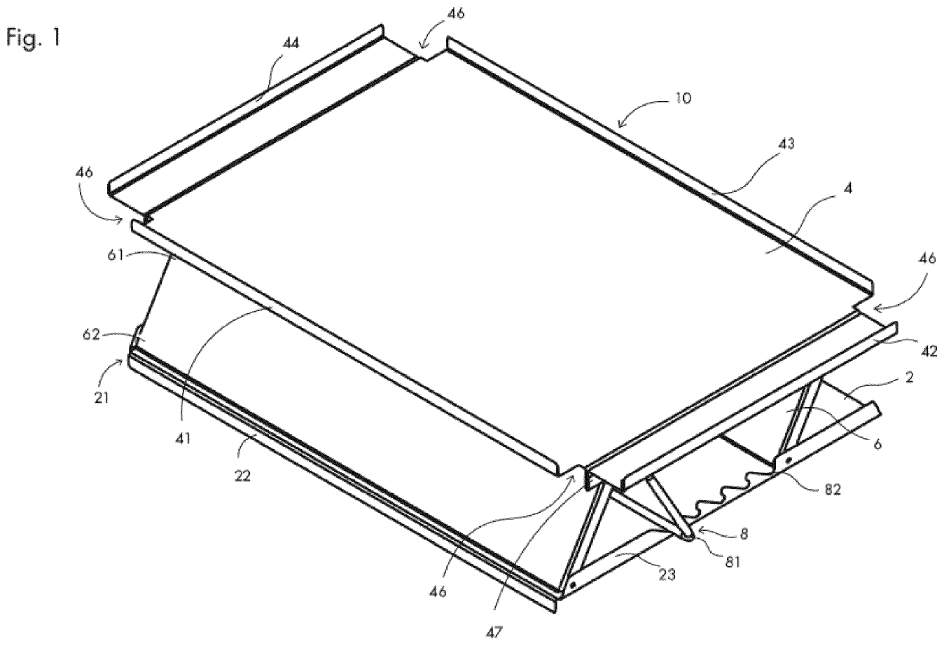

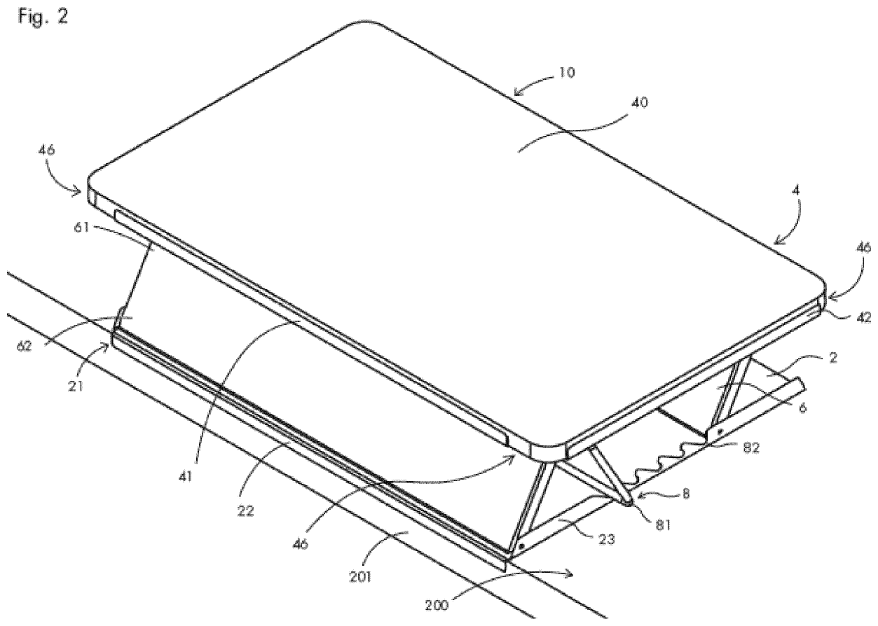

Referring to FIG. 1 and FIG. 2, a perspective view of the height-adjustable cutting-board assembly 10 is shown. Both figures show a support base 2, arranged to support the height-adjustable cutting-board assembly 10. The shown support base 2 is formed of a rectangular plate-shaped structure. The support base 2 comprises two edges 23 on opposed lateral sides of the support base 2. The edges 23 of the support base 2 are pivotably connected to two struts 6. The struts 6 are elongated plate-shaped struts, which extend over substantially the entire width of the support base 2. The struts 6 comprise a top end 61 and a bottom end 62. The struts 6 are connected to the support base 2 at their bottom end 62. The struts 6 are further pivotably connected to a cutting-board holder 4 at their top end 61. The cutting-board holder 4 comprises downwardly extending edges 47 on opposed lateral side regions of the cutting-board holder 4. These edges 47 of the cutting-board holder 4 are pivotably connected to the top ends 61 of the struts 6. The struts 6 are positioned substantially parallel to each other to form a moveable parallelogram lift whereby said cutting-board holder 4 is height-adjustable in relation to the support base 2 by pivoting the struts 6 in relation to the support base 2 and the cutting-board holder 4.

The cutting-board holder 4 is arranged to receive a cutting-board 40 as shown in FIG. 2. The cutting-board holder 4 defines a substantially rectangular shape, having four peripheral edges from which four wall elements 41, 42, 43, 44 extend upwardly. These wall elements 41, 42, 43, 44 secure the cutting-board 40 on the cutting-board holder 4. In FIG. 2, only wall elements 41 and 42 can be seen due to the cutting-board 40 being disposed in the cutting-board holder 4. The height-adjustable cutting-board assembly 10 further comprises a securing mechanism 8, arranged to releasable secure the struts 6 in one or more predetermined positions. The securing mechanism 8 comprises a support arm 81, which extends from the cutting-board holder 4. The support base 2 comprises one or more catches 82, arranged to receive the support arm 81. In the shown embodiment, the support base 2 comprises 5 catches.

In the shown embodiment, the cutting-board holder 4 has a rectangular shape so that it has four corners. The corners of the cutting-board holder 4 comprise notches 46, so that the cutting-board 40 may be easily retrieved from the cutting-board holder 4. The support base 2 comprises a front edge 21 comprising a lip 22 extending downwardly from the front edge of the support base 2. FIG. 2 shows the lip 22 being arranged to abut a work surface edge 201 on a side of a work surface 200.

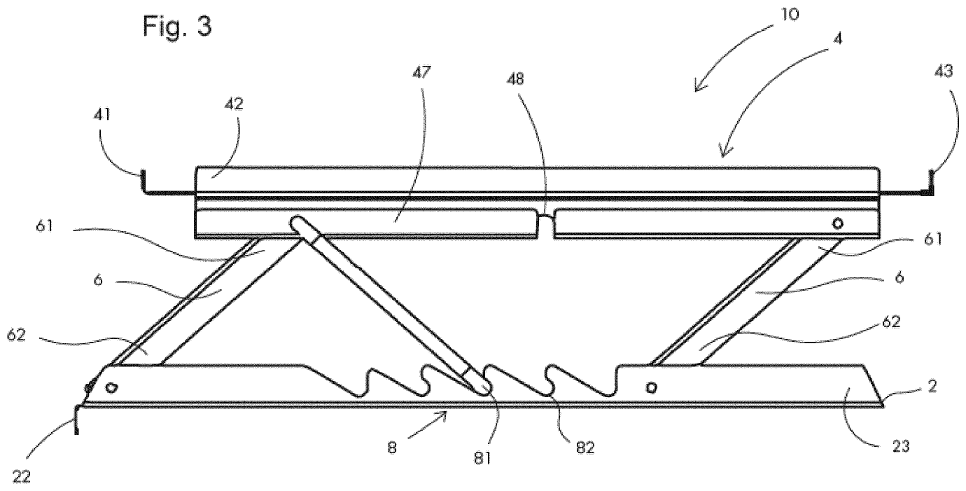

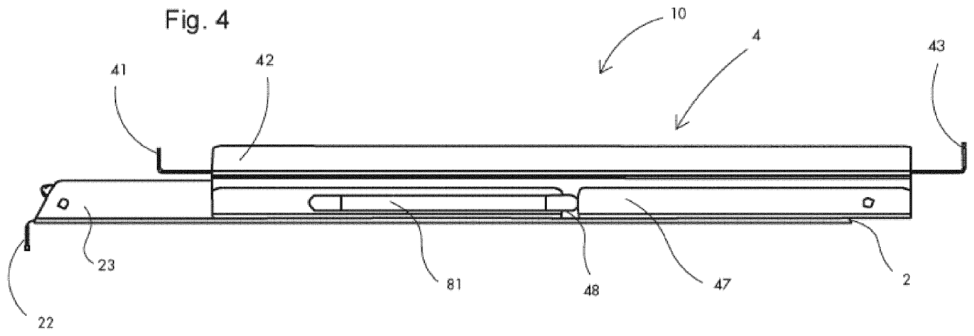

Referring to FIG. 3 and FIG. 4, a side view of the height-adjustable cutting-board assembly 10 is shown. FIG. 3 shows an embodiment in partially raised state while FIG. 4 shows an embodiment in a completely collapsed state. The side views show the support base 2 and the cutting-board holder 4, both being pivotably connected by two struts 6 at the bottom end 62 and the top end 61 of the struts, respectively. The side view of FIG. 3 clearly shows how the support arm 81 of the securing mechanism 8 is received in one of the catches 82 of the support base 2 to secure the struts 6 in a predetermined position. By positioning the support arm 81 in another one of the catches 82, the height of the cutting-board holder 4 is adjusted.

FIG. 4 shows a side view of the height-adjustable cutting-board assembly 10 in a collapsed state. The struts 6 are positioned substantially horizontally, as is the support arm 81 of the securing mechanism 8. As a result, the cutting-board holder 4 is in its lowest position, which defines the minimum height of the height-adjustable cutting-board assembly 10. The downwardly extending edges 47 of the cutting-board holder 4 comprises an aperture 48, into which the support arm 81 of the securing mechanism 8 is received when the height-adjustable cutting-board assembly 10 is in its collapsed state. Since the support base 2, the struts 6, the support arm 81, and the cutting-board holder 4 are all in a horizontal position in the collapsed state, the height of the assembly 10 is minimized in a collapsed state.

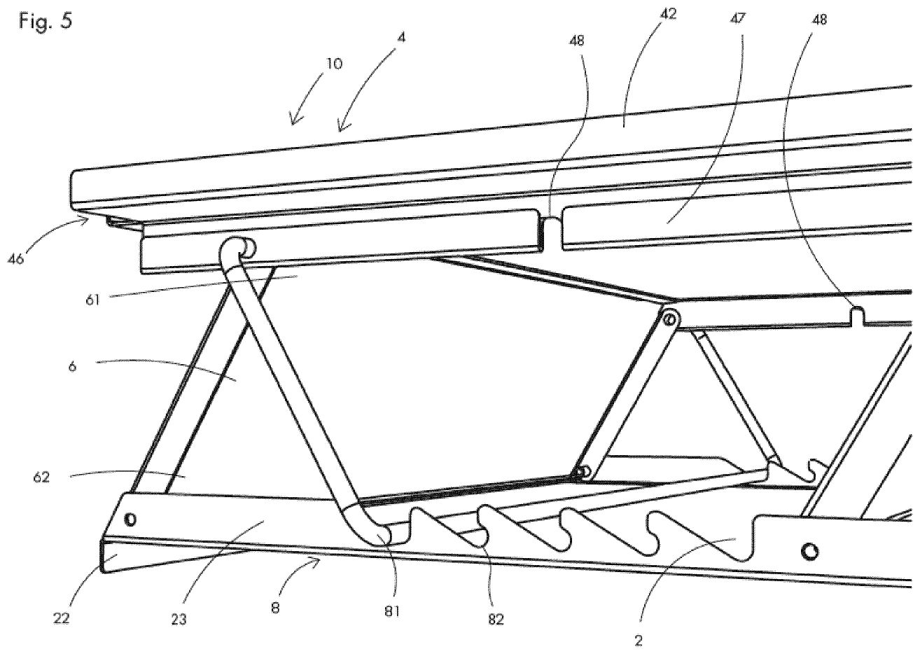

Referring to FIG. 5, a perspective close-up view of the height-adjustable cutting-board assembly 10 is shown. The securing mechanism 8 is shown in greater detail. The support arm 81 extends from the downwardly extending edges 47 of the cutting-board holder 4 and is pivotably connected on the same hinge as one of the struts 6. The struts 6 are connected between the support base 2 and the cutting-board holder 4. The downward movement of the struts 6 is restricted by the securing mechanism 8. The support arm 81 is received in one of the catches 82 of the support base 2, thereby blocking the downward movement of the cutting-board holder 4 and the struts 6. In the shown embodiment, the support arm 81 is received in the most forward catch 82, which places the height-adjustable cutting-board assembly 10 in its most upright position, generating the most height of the cutting-board holder 4. The embodiment also shows the aperture 48 in the downwardly extending edges 47 of the cutting-board holder 4, which are arranged to receive the support arm 81 once the height-adjustable cutting-board assembly 10 is collapsed.

The invention has been described by reference to certain embodiments discussed above. It will be recognized that these embodiments are susceptible to various modifications and alternative forms well known to those of skill in the art.

Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A height-adjustable cutting-board assembly (10) comprising:
a support base (2) being arranged to rest on a work surface, such as a countertop or a table;
a cutting-board holder (4), arranged to receive a cutting-board;
at least two struts (6), said at least two struts (6) connecting the support base (2) with the cutting-board holder (4); wherein said at least two struts (6) each comprise a top end (61) and a bottom end (62), said top end (61) being pivotably connected to the cutting-board holder (4) and the bottom end (62) being pivotally connected to the support base (2),
wherein said struts (6) are positioned substantially parallel to each other to form a moveable parallelogram lift, whereby said cutting-board holder (4) is height adjustable in relation to the support base (2) by pivoting the struts (6) in relation to the support base (2) and the cutting-board holder (4).

2. The height-adjustable cutting-board assembly (10) of claim 1, wherein the struts (6) have an elongated width, so that the struts (6) preferably form a plate-shaped structure, wherein preferably a width of the struts (6) extends over a width of the cutting-board holder (4) for at least about 50%, preferably for at least about 70%, more preferably for at least about 80%.

3. The height-adjustable cutting-board assembly (10) of any of the preceding claims, wherein the struts (6) have a length between the top end (61) and the bottom end (62) of the struts (6) of between about 5 cm and 20 cm, preferably of between about 8 cm and 18 cm, more preferably of between about 10 cm and 15 cm, still more preferably of between about 12 cm and 14 cm.

4. The height-adjustable cutting-board assembly (10) of any of the preceding claims, wherein the height-adjustable cutting-board assembly (10) has a minimum height of less than about 9 cm, preferably of less than about 7 cm, more preferably of less than about 5 cm, still more preferably of less than about 3 cm, most preferably of less than about 2 cm.

5. The height-adjustable cutting-board assembly (10) of any of the preceding claims, wherein the cutting-board holder (4) defines a substantially rectangular shape, having four peripheral edges, wherein the cutting-board holder (4) comprises four wall elements, extending upwardly from the peripheral edges of the cutting-board holder (4).

6. The height-adjustable cutting-board assembly (10) of any of the preceding claims, wherein the cutting-board holder (4) has a larger width than the support base (2), preferably the width of the cutting-board holder (4) is more than about 2 cm larger, preferably more than about 4 cm larger, more preferably more than about 6 cm larger, still more preferably more than about 8 cm larger.

7. The height-adjustable cutting-board assembly (10) of any of the preceding claims, wherein the cutting-board holder (4) comprises at least two notches provided at substantially opposing regions of the periphery of the cutting-board holder (4), wherein preferably the cutting-board holder (4) has a rectangular shape, and wherein preferably the notches are provided in two opposing corner regions of the rectangular cutting-board holder (4), wherein more preferably all corners comprise notches.

8. The height-adjustable cutting-board assembly (10) of any of the preceding claims, wherein the support base (2) comprises a front edge, and wherein the front edge of the support base (2) comprises a lip extending downwardly from the front edge of the support base (2), the lip preferably being arranged to abut a work surface edge.

9. The height-adjustable cutting-board assembly (10) of any of the preceding claims, further comprising a securing mechanism, the securing mechanism comprising a support arm, preferably extending from the cutting-board holder (4), and wherein the support base (2) comprises one or more catches, arranged to receive the support arm, preferably wherein the support base (2) comprises at least 3 catches, more preferably at least 5 catches, still more preferably 7 catches.

10. The height-adjustable cutting-board assembly (10) of claim 9, wherein the support arm comprises a laterally extending engagement, preferably wherein the laterally extending engagement is positioned at a maximum distance from the a lateral edge of the cutting-board holder (4) of about 20 cm, preferably of about 15 cm, more preferably of about 10 cm, still more preferably of about 5 cm.

11. The height-adjustable cutting-board assembly (10) of any of the preceding claims, wherein the cutting-board holder (4), the support base (2), and the struts (6), are fabricated from sheet metal, preferably folded sheet metal.

12. The height-adjustable cutting-board assembly (10) of any of the preceding claims, wherein the height-adjustable cutting-board assembly (10) is arranged to support a weight on the cutting-board holder (4) of at least about 20 kg, preferably of at least about 40 kg, more preferably of at least about 60 kg, still more preferably of at least about 80 kg.

13. A kit of parts comprising:
a height-adjustable cutting-board assembly (10) according to any of the preceding claims; and
a cutting-board, preferably wherein the cutting-board has a width and a length that are substantially equal to a width and a length of the cutting-board holder (4) of the height-adjustable cutting-board assembly (10).

14. A food preparation surface comprising:
a height-adjustable cutting-board assembly (10) according to any of claims 1-12; and
a cutting-board provided on the cutting-board holder (4) of the height-adjustable cutting-board assembly (10).

15. A method of food preparation, comprising the steps of:
providing a food preparation surface according to claim 14, and
processing food on the cutting-board.
